(19) United States
(12) Patent Application Publication
(10) Pub. No.: US 2011/0019414 A1
(43) Pub. Date: Jan. 27, 2011

(54) LED DISPLAY DEVICE

(75) Inventors: Hua Jiang, Shenzhen City (CN); Jin-Wu Zhang, Shenzhen City (CN)

Correspondence Address: Shenzhen Liantronics Co., Ltd., 6/F 119 Shensha Road, Shatoujiao Yantian, Shenzhen, CN

(73) Assignee: Shenzhen Liantronics Co., Ltd., SHENZHEN CITY (CN)

(21) Appl. No.: 12/507,088

(22) Filed: Jul. 22, 2009

(51) Int. Cl. F21V 21/00; F21V 19/00

(52) U.S. Cl. 362/249.02; 362/382

(57) ABSTRACT

A LED display device (100) includes a base (2) and at least one front door (1). A LED module (10) is secured in the front door. The front door is rotatablely engaged with the base, and can be opened at any angle from or intimately closed over the base. The LED display device supplies an easy access from the front for attachment or detachment of an LED module by opening the front door. It is easy and efficient for installations since a space from the back of the LED display device for maintenance is not necessary.

### BACKGROUND OF THE INVENTION

The present invention relates to a LED display device, and especially to a LED display device for being quickly and readily maintained.

In resent years, a LED display has been widely used in every field, such as advertisement, general-purpose illumination, or in architectural and video display applications. An environment and position for installing the LED display device is various and even may be very unfavourable. On the other hand, conventional LED display apparatus could be accessed only from the back side when any maintenance is desired such as replacement of nonfunctioning LED (light emitting diode) pixels, faulty circuitry, installation of updated circuitry, cleaning, and other situations requiring removal or replacement of the LED modules. Accordingly, it is always necessary to reserve a relevant space from the back side of the device when mounting it for the sake of maintenance, while it is unavailable in a narrow mounting condition. As result, it is difficult to maintain the LED modules.

A system can be accessed from the front for attachment or detachment of an LED module, as shown in U.S. Pat. No. 6,816,389, and its LED module having one or more positionable helical spring latches adjacent to the geometry of a mounting panel is secured to a mounting panel by engagement of the helical spring latches. Each helical spring latch includes a pivot pin and a helical spring which are rotatingly positioned to cause intimate rotational engagement of the helical springs with the geometry of the mounting panel. However, the latch system is very complex which needs so many posts, holes, pins, springs, nuts aligned to and engaged with one another. Thereby, it is very arduous and as well easy to make mistakes to align and arrange so many parts one by one. Additionally, a plurality of access holes are defined through the outer louver panel of the LED module, which affect display appearance, and dust, moisture or the like will easily enter into the inner thereof. Furthermore, heat elimination is not effective.

Therefore, an improved LED display device is desired which overcomes the disadvantages of the prior art.

### BRIEF SUMMARY OF THE INVENTION

A main object of the present invention is to provide a LED display device, which can supply an easy access from the front for maintenance of an LED module by a simple method, and which is simple and efficient for installation, too.

To obtain the above object, a LED display device in the present invention comprises a base and at least one front door. A LED module is secured in the front door. The front door is rotatablely engaged with the base, and can be opened at any angle from or intimately closed over the base.

Engagement means between the front door and the base include a hinge, a chain, a shaft, a spindle, a wheel, or a mechanical coupling or the like.

A printer circuit board is arranged in the base to electrically control the LED module in the front door. Herein, the LED module is electrically connected to the printer circuit board using a flexible printed circuit or the like.

The front door defines a frame to enclose the LED module therein. Correspondingly, the base configures a flange. The frame can seal over the flange, whereby the front door is intimately closed on the base. A gasket or seal washer may be inserted between the frame and the flange.

A groove is formed along the flange in the base, and engaged with an extension formed from the front door toward the base, whereby water can be drained away along the groove. A sealing washer may be set between the groove and the extension of the front door.

An air window is defined at the back, and an air passage is formed through the base from the air window to the front of the base.

A safety device such as a safety rope or the like, is secured between the front door and the base where it is desired to prevent accidental dropping of the front door.

To obtain the above object, a LED display device in another embodiment of the present invention comprises a base and front doors. LEDs are arranged in the front doors. The front doors are respectively rotatablely engaged with the base, and can be opened at any angle from or intimately closed over the base. When the front doors are closed, the LEDs can display as an integral.

The number of the front doors is two. Herein, two front doors can oppositely engage with any side of the base.

There are a plurality of doors respectively rotatablely engaged with any side of the base according to the size of the LED module.

Other objects, advantages and novel features of the invention will become more apparent from the following detailed description of a preferred embodiment thereof when taken in conjunction with the accompanying drawings, wherein:

### BRIEF DESCRIPTION OF THE DRAWINGS

FIG. 1 is a schematic, perspective view of a LED display device in accordance with an embodiment of the present invention;

FIG. 2 is a schematic, top view of the LED display device of FIG. 1;

FIG. 3 is a schematic, back view of the LED display device of FIG. 1;

FIG. 4 is a schematic, front view of the LED display device of the present invention in an open state;

FIG. 5 is a schematic, top view of the LED display device of the present invention in another open state;

FIG. 6 is a schematic, top, cross-sectional view of the LED display device of the present invention in a third open state;

FIG. 7 is a schematic, top, cross-sectional view of a LED display device of FIG. 6 in a closed state; and

FIG. 8 is an enlarged view of section a of FIG. 7.

### DETAILED DESCRIPTION OF THE INVENTION

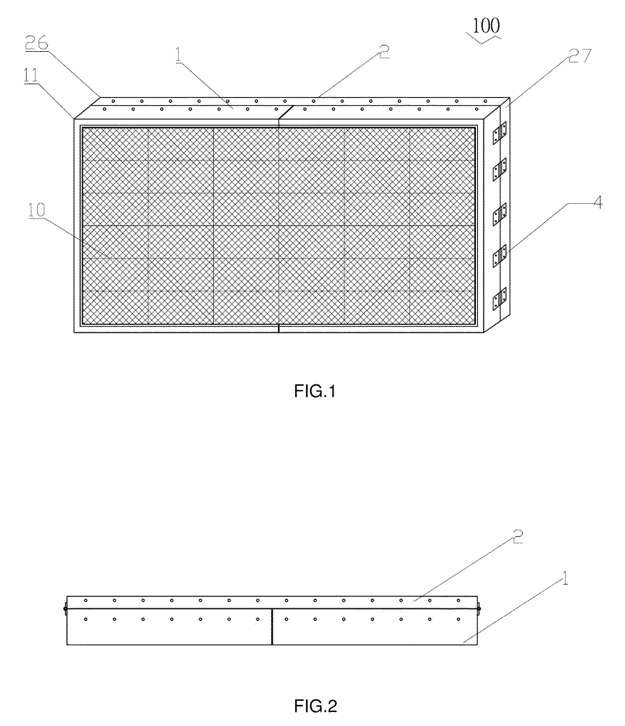

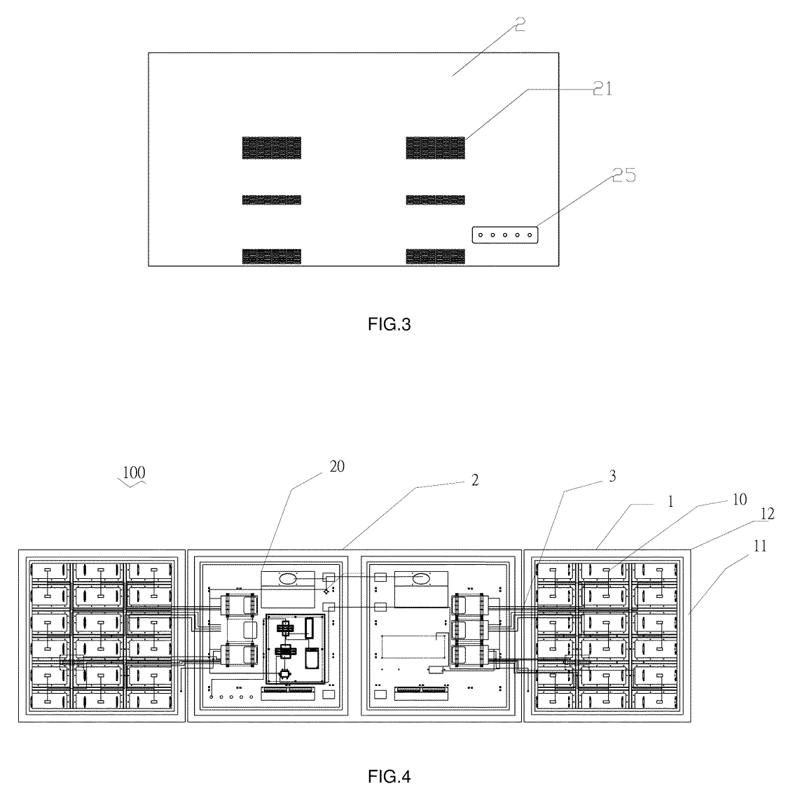

Referring to FIGS. 1 to 3 together, a LED display device 100 according to the embodiment of the present invention includes two front doors 1 and a base 2. The doors 1 are rotatablely engaged with the base 2 respectively at a left side 26 and a right side 27 thereof, and can be oppositely opened from or intimately closed to the base 2. The engagement between the door 1 and base 2 is hinges 4. Each front door 1 has a housing 11, and LED module 10 is positioned in the housing 11 (as shown in FIG. 1). It is understood that two front doors 1 can engaged with the base 2 at other sides thereof. For instance, one door is hinged to the base 2 at the left side; the other is hinged at the top or lower side. While the doors are close, the LED module always display as an integral.

The base 2 confines one or more air windows 21 and functional putouts 25 at the back thereof. The functional putouts are used such as Data in, Data out, DOT check out, AC out, or AC in.

FIG. 4 shows an electrical connection of the LED display device 100 of the present invention. Herein, a printed circuit board 20 is accommodated in the base 2 to electrically control the LED module 10. LDE module 10 is composed of a plurality of LEDs arranged in the housing 11, and electrically connected with the printed circuit board 20 using a kind of connector 3 such as a flexible printed circuit or the like. The housing 11 defines a frame 12 (shown in FIGS. 4 and 8) surrounding the LED module 10.

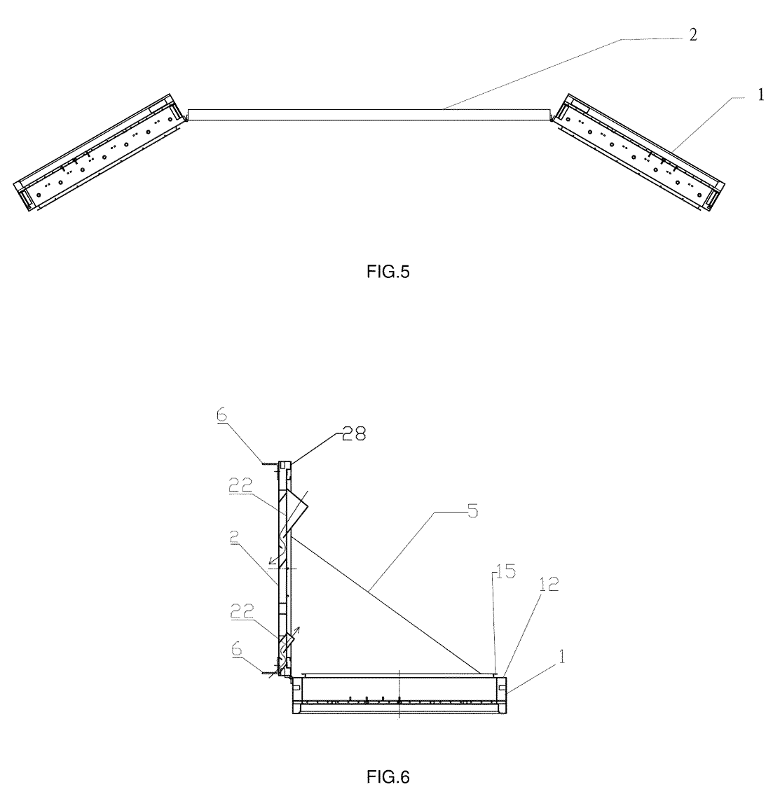

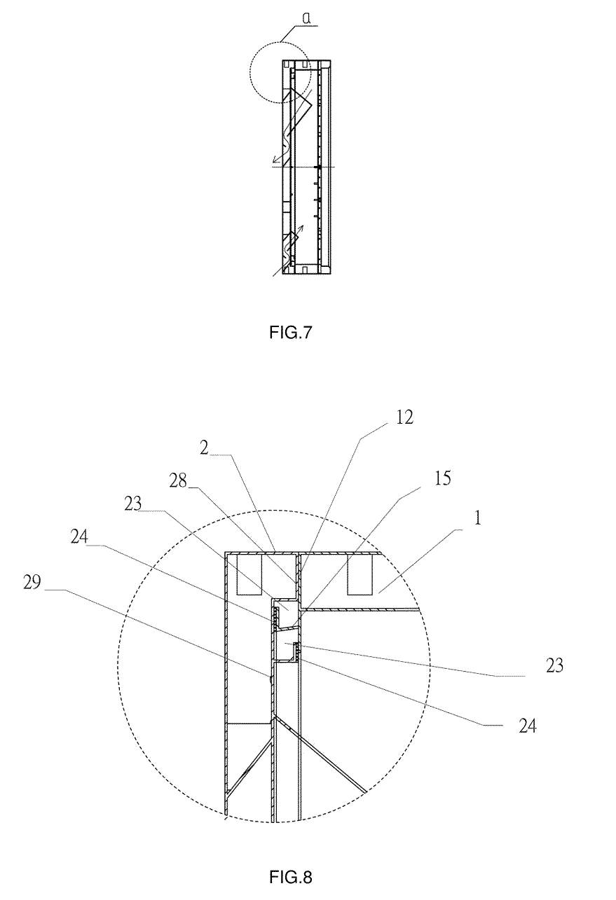

The doors 1 can freely be opened from the base 2 at any angle as shown in FIGS. 5 and 6. A safety device such as a lanyard 5 is secured with one end to the base 2 and the other end to each door 1, which is used in service work where it is desired to prevent accidental dropping of the LED module 10. FIG. 6 illustrates half structure of the LED display device 100 with one door 1 open at a right angle. And FIG. 7 shows the structure when the door 1 is closed. A plurality of air passages 22 are configured through the base 2, which extend from the windows 21 to the front of the base 2 for air inlet, and reversely, from the front of the base 2 to the windows 21 thereof for air outlet. Therefore, air can be circulated from the outer to the inside of the device 100, and heat is dissipated. Mounting fixtures 6 are used to secure the device 100.

Also referring to FIG. 8, a flange 28 is configured around the front of the base 2 corresponding to the frame 12 of the housing 11. The frame 12 can seal the flange 28 when the doors 1 are closed on the base 2. Therefore, the LED display device 100 is sealed. In addition, gaskets or sealing washers can be applied between the flange 28 and the frame 12 for better sealing thereof.

The base 2 defines a recess 29 along the flange 28 in the front to accommodate an backward extension 15 (shown in FIGS. 6 and 8) of the door 1 when door 1 is closed. A groove 23 is formed along the flange 28 and in the recess 29 of the base 2, from which water can drain away. Gaskets 24 are secured to the surface of the groove 23, and positioned between the extension 15 of the door 1 and the groove 23 for sealing the LED module 10. Therefore, water will only flow out through the groove 23.

It is seen from the above that, when the LED display device 100 of the present invention is assembled and put into use, the doors 1 are closed, the device 100 displays as an integral, and it is effective for air ventilation, heat dissipation, and waterproof. When any maintenance is desired, the device 100 can be easily accessed from the front by opening the front doors 1 from the base 1 even without any hand tool. Furthermore, a space from the back of the device 100 is not necessary any more in virtue of the front access, which is very convenient for installing the device 100.

It is understood that other rotatably connecting means between each door 1 and the base 2, such as chains, shafts, spindles, wheels, mechanical coupling or the like are applicable, too. Herein, the mechanical coupling includes any mechanical and rotatablely connecting means, for instance, a ring and a hook, buckles, clasp, etc.

In other embodiment, only one door 1 is set on the base 2. Herein, the hinges 4 are set at any side of the door 1 and the base 2, such as at left or right, top or lower side.

In more embodiment of the present invention, a plurality of doors 1 may be set on the base 2 according to the size of the LED module 10. The position of the engagement between each door 1 and the base 2 may be set at any side of the base 2 or the door 1. For instance, one door is engaged at a right side, one is engaged at a left side, and others may be engaged at either the top or lower side of the base 2.

What is claimed is:

1. A LED display device comprising:
a base; and
at least one front door;
wherein a LED module is secured in said front door; said front door is rotatablely engaged with said base, and can be opened at any angle from or intimately closed over said base.

2. The LED display device according to claim 1, wherein engagement means between said front door and said base comprise a hinge, a chain, a shaft, a spindle, a wheel, or a mechanical coupling.

3. The LED display device according to claim 1, wherein a printer circuit board is arranged in said base to electrically control said LED module in said front door.

4. The LED display device according to claim 3, wherein said LED module in said front door is electrically connected to said printer circuit board using a flexible printed circuit.

5. The LED display device according to claim 1, wherein said front door defines a frame to enclose said LED module therein, said base configures a flange, and said frame can seal over said flange, whereby said front door is intimately closed on said base.

6. The LED display device according to claim 5, wherein a sealing washer is inserted between said frame and said flange.

7. The LED display device according to claim 5, wherein a groove is formed along said flange in said base, and engaged with an extension formed from said front door toward said base, whereby water can be drained away along said groove.

8. The LED display device according to claim 7, wherein a gasket is inserted between said groove and said extension of said front door.

9. The LED display device according to claim 1, wherein an air window is defined at the back of said base, and an air passage is formed through said base from said air window to the front of said base.

10. The LED display device according to claim 1, wherein a safety device is secured between said front door and said base where it is desired to prevent accidental dropping of the LED module in said front door.

11. A LED display device comprising:
a base; and
front doors;
wherein LEDs are arranged in said front doors; said front doors are respectively rotatablely engaged with said base, and can be opened at any angle from or intimately closed over said base; and when said front doors are closed, said LEDs can display as an integral.

12. The LED display device according to claim 11, wherein a printer circuit board is arranged in said base to electrically control said LEDs arranged in said front doors.

13. The LED display device according to claim 12, wherein said LEDs in said front doors are electrically connected to said printer circuit board using a flexible printed circuit.

14. The LED display device according to claim 11, wherein each front door defines a frame to enclose said LEDs therein; said base configures a corresponding flange; and said frame can seal over said flange, whereby each front door is intimately closed on said base.

15. The LED display device according to claim 14, wherein a sealing washer is inserted between said frame and said flange.

16. The LED display device according to claim 14, wherein grooves are formed along said flange in said base, and engaged with an extension formed from each front door toward said base, whereby water can be drained away along said grooves.

17. The LED display device according to claim 16, wherein gaskets are inserted between said groove and said extension of each front door.

18. The LED display device according to claim 11, wherein air windows defined at the back of said base, and air passages are formed through said base from said air windows to the front of said base.

19. The LED display device according to claim 11, wherein the number of said front doors is two.

20. The LED display device according to claim 11, wherein said front doors are a plurality of front doors respectively rotatablely engaged with any side of said base.
